(19) United States
(12) Patent Application Publication
(10) Pub. No.: US 2021/0056520 A1
(43) Pub. Date: Feb. 25, 2021

(54) ELECTRONIC EXCHANGE VISIBILITY PLATFORM

(71) Applicant: BANK OF AMERICA CORPORATION, Charlotte, NC (US)

(72) Inventors: Kevin Patrick Thomsen, New York, NY (US); Michael John Letson, Charlotte, NC (US)

(73) Assignee: BANK OF AMERICA CORPORATION, Charlotte, NC (US)

(21) Appl. No.: 16/549,504

(22) Filed: Aug. 23, 2019

(51) Int. Cl. G06Q 20/10; G06Q 20/06

(52) U.S. Cl. CPC G06Q 20/10; G06Q 20/065

(57) ABSTRACT

Embodiments of the invention are directed to a system, method, or computer program product for digital resource exchange visibility. The system identifies information associated with activities on potential digital resource exchanges. The system identifies potential digital resource exchanges and introduces an entity controlled account for funding and reversing funding on a digital resource exchange. The account may be translated to the exchange as a realistic account utilizing the various payment channels for interaction with the digital resource exchange. Once an interaction occurs via the exchange, the system may be able to perform back end searching for data extraction about the interaction. The system is utilized as intelligence to flag interactions.

### BACKGROUND

With the advent of digital resource exchanges a gap has been created in visibility into resource distributions across entity accounts. Typically the digital resource exchange determines the text used in the description field and are not necessarily self-identified as a resource exchange. As such, entities are blind to regulatory situations and misappropriation actions. As such, a need exists for tracking and mitigating the visibility gap in digital resource exchange networks.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address these and/or other needs by providing an innovative system, method, and computer program product for an electronic exchange identification and visibility platform.

The advent of digital resource exchanges has created a gap in entity, specific financial institution entities, visibility of resource distributions across financial institution accounts to a digital resource exchange. The digital resource determines the text used in the transaction description field of the transaction and if the exchange does not self-identify as a digital resource exchange, then entity is blind to the transaction type and whether it involves digital resources. The gap created by this blindness puts financial institutions in regulatory, compliance, and/or credit risk situations by not being able to identify resource accounts involved in potential misappropriation activities. Typically, digital resource exchanges that are preforming non-conforming activities do not self-declare as a digital resource exchange, but instead declare as an on-line retailer as an example. Thus, financial institutions cannot identify the non-conforming activity and accounts associated therewith. Thus potentially being in contrast with regulatory compliance. When there is no identifier information in the payment description that the transaction involves a digital resource, there is a gap. As such, a need exists to close this gap and provide a system to identify the exchanges and the accounts associated therewith.

In some embodiments, the process identifies and tags accounts and exchanges associated with potential digital misappropriation. In some embodiments, the invention may utilize entity systems and servers to perform portions of the process. The system sets up a digital resource account or wallet on that exchange. The system funds the digital resource account with entity or financial institution funds for each possible payment channel, such as wire, ACH, debit, and/or credit and/or other fiat currency payment channels. Once a transaction occurs via the exchange, the system may be able to perform back end searching to look up the resource distribution. Doing so, the system identifies the resource account associated with the digital resource exchange. The system tags the account and the exchange and stores the tagged information to maintain an inventory of digital resource exchanges and the account used to support the exchanges. The system is utilized as intelligence to flag accounts transacting with the most risky exchanges for regulatory compliance and misappropriation actions.

Embodiments of the invention relate to systems, methods, and computer program products for electronic exchange visibility, the invention comprises: identifying a digital resource exchange; setting up an entity controlled presence on the digital resource exchange, wherein the entity controlled presence includes a digital resource accounts; funding the entity controlled presence on the digital resource exchange with resources from an account associated with the entity, wherein the funding occurs for each payment channel; reversing the funding from the entity controlled presence on the digital resource exchange to the account associated with the entity for each payment channel; extracting, via entity based backend processor, information about the digital resource exchange based on the funding and reversing performed, wherein the information about the digital resource exchange further comprises an identification of an appearance of the funding and the reversing on the digital resource exchange for each transaction via each of the payment channels; tagging the extracted information as being associated with the digital resource exchange; and allowing for entity based decisioning for entity user processing on the digital resource exchange.

In some embodiments, decisioning for entity user processing on the digital resource exchange further comprises declining, holding, or accepting entity user transactions across the digital resource exchange.

In some embodiments, the digital resource account comprise one or more payment channels such that upon performing processing on the digital resource exchange via the entity controlled presence using the digital resource account identifies a processing procedure for each of the digital resource accounts on the digital resource exchange.

In some embodiments, the digital resource exchange is a cryptocurrency exchange.

In some embodiments, setting up the entity controlled presence on the digital resource exchange further comprises enrolling the digital resource account on the digital resource exchange for performing transactions across the digital resource exchange via digital resource accounts.

In some embodiments, performing processing on the digital resource exchange via the entity controlled presence, further comprises conducting one or more transactions across the exchange.

In some embodiments, reversing the funding from the entity controlled presence on the digital resource exchange comprises confirming whether the digital resource entity uses a matching payment mechanism to extract funds from the entity and to fund the digital resource entity or confirming whether there is no match between the payment mechanism used to extract funds from the entity and to fund the digital resource entity.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 provides an electronic exchange visibility system environment, in accordance with one embodiment of the present invention;

FIG. 2 provides a digital resource exchange system environment architecture, in accordance with one embodiment of the present invention;

FIG. 3 provides a high level process flow illustrating identification and tagging of digital resource exchanges, in accordance with one embodiment of the present invention;

FIG. 4 provides a high level process flow illustrating an identification and tagging of digital wallets associated with a digital resource exchange, in accordance with one embodiment of the present invention; and

FIG. 5 provides a high level process flow illustrating identifying and tagging using electronic exchange visibility system, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

A “user” as used herein may refer to an individual that may have one or more accounts associated with the individual. Furthermore, as used herein the term “user device” or “mobile device” may refer to mobile phones, personal computing devices, tablet computers, wearable devices, and/or any portable electronic device capable of receiving and/or storing data therein.

An “account” is the relationship that a user has with an entity or another entity, such as a financial institution. Examples of accounts include a deposit account, such as a transactional account (e.g., a banking account), a savings account, an investment account, a money market account, a time deposit, a demand deposit, a pre-paid account, a credit account, a non-monetary user profile that includes information associated with the user, or the like. The account is associated with and/or maintained by the entity. “Resources” include accounts of the user and/or other property owned by the user. The resources may be associated with accounts or may be property that is not associated with a specific account. Examples of resources associated with accounts may be accounts that have cash or cash equivalents, or accounts that are funded with or contain property, such as safety deposit box account, a trust account that is funded with property, or the like. Examples of resources that may not be associated with accounts may be antiques in a user's home, jewelry in a user's home, or the like. “Funds” or “Available Balance” are a balance in an account that can be invested or withdrawn. For example, the funds may refer to a bank ledger balance minus the amount of any monetary checks in the process of collection. Funds may also be referred to as an available balance, a collected balance, good funds, and usable funds.

A “transaction” or “resource distribution” refers to any communication between a user and the financial institution or other entity monitoring the user's activities. Alternatively, in some embodiments, the term “transaction” may be used when describing the block chain database as a transaction type of record. The transaction type records consists of the actual data stored in the block chain. A transaction may refer to a purchase of goods or services, a return of goods or services, a payment transaction, a credit transaction, or other interaction involving a user's account. In the context of a financial institution, a transaction may refer to one or more of: a sale of goods and/or services, initiating an automated teller machine (ATM) or online banking session, an account balance inquiry, a rewards transfer, an account money transfer or withdrawal, opening a bank application on a user's computer or mobile device, a user accessing their e-wallet, or any other interaction involving the user and/or the user's device that is detectable by the financial institution. A transaction may include one or more of the following: renting, selling, and/or leasing goods and/or services (e.g., groceries, stamps, tickets, DVDs, vending machine items, and the like); making payments to creditors (e.g., paying monthly bills; paying federal, state, and/or local taxes; and the like); sending remittances; loading money onto stored value cards (SVCs) and/or prepaid cards; donating to charities; and/or the like.

In some embodiments, the term digital resource exchange or exchange refers to one or more cryptocurrency exchanges on a network. In some embodiments, the term digital resource refers to cryptocurrency or a cryptocurrency digital resource account or wallet used to perform transactions across a digital resource exchange. In some embodiments, the term digital misappropriation refers to misappropriation, cyber misappropriation, or actions outside of regulatory and/or policy compliance, or the like.

In some embodiments, the term digital resource account or wallet may refer to any of one or more digital resource wallet, mobile wallet, or digital resource platform that may connect with or be associated with a digital resource exchange for the exchange of resources across the digital resource exchange.

The advent of digital resource exchanges has created a gap in entity, specific financial institution entities, visibility into resource distributions to and from digital resource exchanges. The digital resource determines the text used in the transaction description field of the transaction and if the exchange does not self-identify as a digital resource exchange, then entity is blind to the transaction type and whether it involves digital resources. The gap created by this blindness puts financial institutions in regulatory compliance situation by not being able to identify resource accounts involved in potential misappropriation activities. Typically, digital resource exchanges that are preforming non-conforming activities do not self-declare as a digital resource exchange, but instead declare as an on-line retailer. Thus, financial institutions cannot identify the non-conforming activity and accounts associated therewith. Thus potentially being in contrast with regulatory compliance. There is typically nothing that identifies the digital resource exchange as such across the payment flow. As such, a need exists to close this gap and provide a system to identify the exchanges and the accounts associated therewith.

The system is utilized to identify and tag accounts and exchanges associated with potential digital misappropriation. As such, identifying the accounts supporting digital resource exchanges. The system sets up an account, such as a digital resource account or wallet on that exchange. The system funds the digital resource account with entity or financial institution funds. Once a transaction occurs via the exchange, the system may be able to perform back end searching to look up the resource distribution. Doing so, the system identifies the unique payment identifier associated with the digital resource exchange. The system tags the resource account and the exchange and store the tagged information to maintain an inventory of digital resource exchanges and the account used to support the exchanges. The system is utilized as intelligence to identify accounts transacting with the most risky exchanges so the resource accounts can be flagged for compliance review.

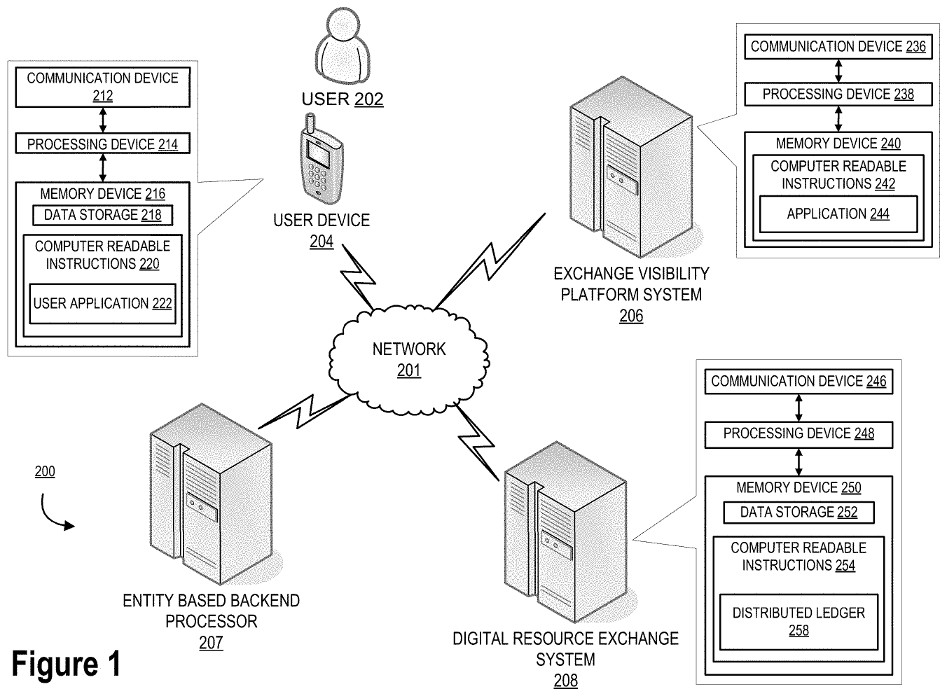

FIG. 1 illustrates an electronic exchange visibility system environment 200, in accordance with one embodiment of the present invention. FIG. 1 provides the system environment 200 for which the distributive network system with specialized data feeds.

FIG. 1 provides a unique system that includes specialized servers and system communicably linked across a distributive network of nodes required to perform the functions disclosed herein.

As illustrated in FIG. 1, the exchange visibility platform 206 can extract information from the user device 204 and digital resource exchange system 208. FIG. 1 illustrates only one example of an embodiment of the system environment 200, and it will be appreciated that in other embodiments one or more of the systems, devices, or servers may be combined into a single system, device, or server, or be made up of multiple systems, devices, or servers.

The entity based backend processor 207 may identify information about the digital resource exchange based on the funding and reversing performed. The information the entity based backend processor 207 may extract comprises information about the digital resource exchange further comprises an identification of an appearance of the funding and the reversing on the digital resource exchange for each transaction via each of the payment channels.

The network 201 may be a system specific distributive network receiving and distributing specific network feeds and identifying specific network associated triggers. The network 201 may also be a global area network (GAN), such as the Internet, a wide area network (WAN), a local area network (LAN), or any other type of network or combination of networks. The network 201 may provide for wireline, wireless, or a combination wireline and wireless communication between devices on the network 201.

In some embodiments, the user 202 is an individual that has one or more digital resource accounts. In some embodiments, the user 202 has a user device, such as a mobile phone, tablet, computer, or the like. FIG. 1 also illustrates a user device 204. The user device 204 may be, for example, a desktop personal computer, a mobile system, such as a cellular phone, smart phone, personal data assistant (PDA), laptop, or the like. The user device 204 generally comprises a communication device 212, a processing device 214, and a memory device 216. The processing device 214 is operatively coupled to the communication device 212 and the memory device 216. The processing device 214 uses the communication device 212 to communicate with the network 201 and other devices on the network 201, such as, but not limited to the exchange visibility platform system 206 and the digital resource exchange system 208. As such, the communication device 212 generally comprises a modem, server, or other device for communicating with other devices on the network 201.

The user device 204 comprises computer-readable instructions 220 and data storage 218 stored in the memory device 216, which in one embodiment includes the computer-readable instructions 220 of a user application 222. In some embodiments, the user application 222 allows a user 202 to complete a transaction.

As further illustrated in FIG. 1, the digital resource exchange system 208 is a system that runs, monitors, or otherwise regulates a digital resource exchange. The digital resource exchange is typically ran via a blockchain distributed network. The digital resource exchange system 208 generally comprises a communication device 246, a processing device 248, and a memory device 250. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 248 is operatively coupled to the communication device 246 and the memory device 250. The processing device 248 uses the communication device 246 to communicate with the network 201 and other devices on the network 201, such as, but not limited to the exchange visibility platform system 206 and the user device 204. As such, the communication device 246 generally comprises a modem, server, or other device for communicating with other devices on the network 201.

As further illustrated in FIG. 1, the digital resource exchange system 208 comprises computer-readable instructions 254 stored in the memory device 250, which in one embodiment includes the computer-readable instructions 254 of the distributed ledger 258. In some embodiments, the memory device 250 includes data storage 252 for storing data related to transactions and payments across the digital resource exchange hosted by the digital resource exchange system 208, but not limited to data created and/or used by the distributed ledger 258.

Embodiments of the digital resource exchange system 208 may include multiple systems, servers, computers or the like maintained by one or many entities. FIG. 1 merely illustrates one of those systems that, typically, interacts with many other similar systems to form the block chain for the digital resource exchange network. In one embodiment of the invention, the digital resource exchange system 208 is operated by a second entity that is a different or separate entity from the exchange visibility platform system 206.

In one embodiment of the digital resource exchange system 208 the memory device 250 stores, but is not limited to a distributed ledger 258. In one embodiment of the invention, distributed ledger 258 may associate with applications having computer-executable program code that instructs the processing device 248 to operate the network communication device 246 to perform certain communication functions involving described herein to create a digital resource exchange network for performing digital resource exchanges or transactions. In one embodiment, the computer-executable program code of an application associated with the distributed ledger 258 may also instruct the processing device 248 to perform certain logic, data processing, and data storing functions of the application.

The processing device 248 is configured to use the communication device 246 to gather data, such as data corresponding to transactions, blocks or other updates to the distributed ledger from various data sources such as other block chain network systems across the digital resource exchange. The processing device 248 stores the data that it receives in its copy of the distributed ledger stored in the memory device 250.

As illustrated in FIG. 1, the exchange visibility platform system 206 generally comprises a communication device 236, a processing device 238, and a memory device 240. The exchange visibility platform system 206 comprises computer-readable instructions 242 stored in the memory device 240, which in one embodiment includes the computer-readable instructions 242 of an institution application 244. The exchange visibility platform system 206 may generate accounts on the digital resource exchange system 208 to identify the exchange and accounts associated therewith. Furthermore, the digital resource exchange system 208 may monitor and consume digital resource transaction data from publicly accessible blockchain distributed ledgers to identify potential digital resource exchange systems 208.

It is understood that the servers, systems, and devices described herein illustrate one embodiment of the invention. It is further understood that one or more of the servers, systems, and devices can be combined in other embodiments and still function in the same or similar way as the embodiments described herein.

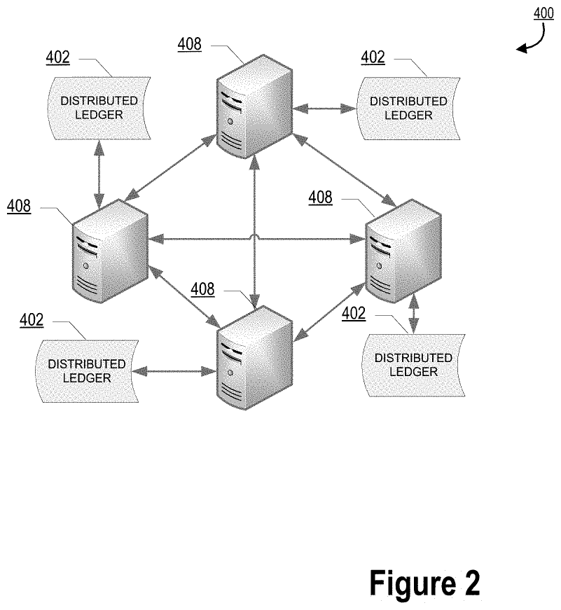

FIG. 2 provides a block chain system environment architecture 400, in accordance with one embodiment of the present invention. Rather than utilizing a centralized database of data for instrument conversion, various embodiments of the invention may use a decentralized block chain configuration or architecture as shown in FIG. 2.

The block chain system typically has two primary types of records. The first type is the transaction type, which consists of the actual data stored in the block chain. The second type is the block type, which are records that confirm when and in what sequence certain transactions became recorded as part of the block chain. Transactions are created by participants using the block chain in its normal course of business, for example, when someone sends cryptocurrency to another person). A “valid” transaction is one that can be validated based on a set of rules that are defined by the particular system implementing the block chain. For example, in the case of cryptocurrencies, a valid transaction is one that is digitally signed, spent from a valid digital wallet and, in some cases that meets other criteria. In some block chain systems, miners are incentivized to create blocks by a rewards structure that offers a pre-defined per-block reward and/or fees offered within the transactions validated themselves. Thus, when a miner successfully validates a transaction on the block chain, the miner may receive rewards or the like as an incentive to continue creating new blocks. In some embodiments, transactions type records comprise various identifications for users.

As mentioned above and referring to FIG. 2, a block chain system 400 is typically decentralized - meaning that a distributed ledger 402 (i.e., a decentralized ledger) is maintained on multiple nodes 408 of the block chain 400. One node in the block chain may have a complete or partial copy of the entire ledger or set of transactions and/or blocks on the block chain. Transactions are initiated at a node of a block chain and communicated to the various nodes of the block chain. Any of the nodes can validate a transaction, add the transaction to its copy of the block chain, and/or broadcast the transaction, its validation (in the form of a block) and/or other data to other nodes. This other data may include time-stamping, such as is used in cryptocurrency block chains.

The advent of digital resource exchanges has created a gap in entity, specific financial institution entities, visibility of resource distributions across financial institution accounts to a digital resource exchange. The digital resource determines the text used in the transaction description field of the transaction and if the exchange does not self-identify as a digital resource exchange, then entity is blind to the transaction type and whether it involves digital resources. The gap created by this blindness puts financial institutions in regulatory or compliance situation by not being able to identify resource accounts involved in potential misappropriation activities. Typically, digital resource exchanges that are preforming non-conforming activities to not self-declare as a digital resource exchange, but instead declare as an on-line retailer. Thus, financial institutions cannot identify the non-conforming activity and accounts associated therewith. Thus potentially being in contrast with regulatory compliance. There is typically nothing that identifies the digital resource exchange as such across the payment flow. As such, a need exists to close this gap and provide a system to identify the exchanges and the accounts associated therewith.

The system is utilized to identify and tag accounts and exchanges associated with potential digital misappropriation. As such, identifying the accounts supporting digital resource exchanges. The system sets up an account, such as a digital resource account or wallet on that exchange. The system funds the digital resource account with entity or financial institution funds. Once a transaction occurs via the exchange, the system may be able to perform back end searching to look up the resource distribution. Doing so, the system identifies the resource account associated with the digital resource exchange. The system tags the account and the exchange and store the tagged information to maintain an inventory of digital resource exchanges and the account used to support the exchanges. The system is utilized as intelligence to flag accounts transacting with the most risky exchanges for regulatory compliance and misappropriation actions.

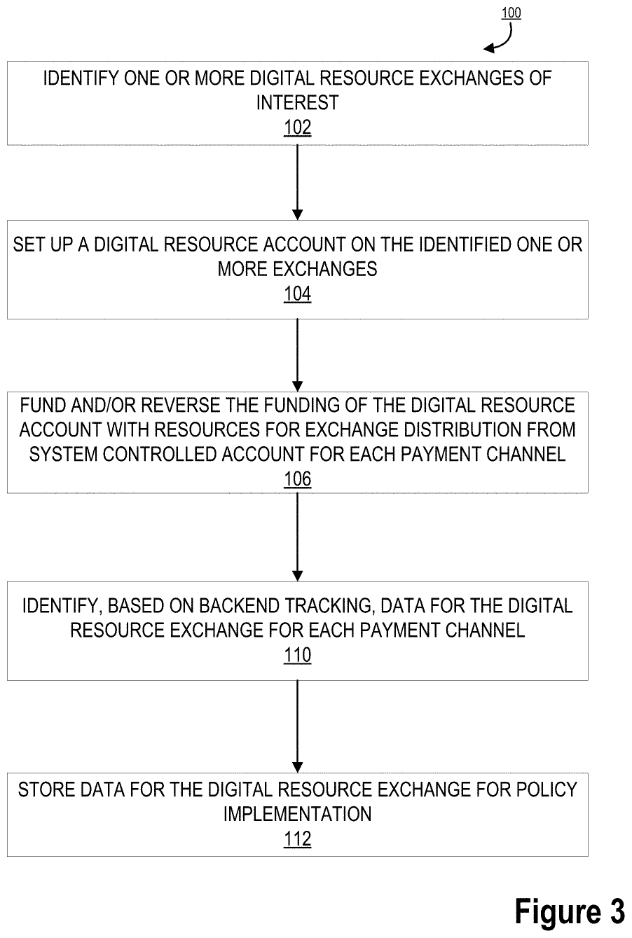

FIG. 3 provides a high level process flow illustrating an identification and tagging of digital resource exchanges 100, in accordance with one embodiment of the present invention. As illustrated in block 102, the process 100 is initiated by identifying one or more resource exchanges of interest. These digital resource exchanges may not be coded as an exchange. As such, the invention provides a process to identify unique payment identifier information associated with the digital resource exchange for each possible resource distribution channel. When the exchange does not include a payment identifier information a financial institution that maintains an account that transacts on the exchange does not typically have visibility to recognize the transaction is being performed on a digital resource exchange. In some embodiments, maintaining accounts that transact on an exchange may lead to the regulatory compliance issues for the financial institution.

In some embodiments, the digital resource exchanges may be identified by machine learning algorithms, manually, or the like. In this way, the system may identify possible exchanges based on back end identification of transactions that follow historic trends associated with exchange transactions. Furthermore, the system may search the internet for exchanges, a user may input potential exchanges known to users, or the like.

Next, as illustrated in block 104, the process 100 continues by the system setting up a digital resource account on the digital resource exchange. In this way, the system may set up a digital resource account and fund the account for each of the possible funding methods or payment channels, such as wire, ACH, or the like that are accepted by the digital resource exchange. The digital resource account may be controlled by the system, such that the system may maintain the transactions using the digital resource account on the digital resource exchange.

As illustrated in block 106, the process 100 continues by funding/reversing the funding of the digital resource account with entity resources for the digital resource exchange for each of the payment channels. In this way, the wallet may be funded with resources for performing transactions on or across the digital resource exchange using various payment channels. The system may then transmit resources across the digital resource exchange to complete a transaction on the digital resource exchange via one or more of the payment channels. Once the transaction across the digital resource exchange has been processed, using the backend networking of the financial institution associated with the system, the system may be able to identify the unique payment information of the transaction across the digital resource exchange. Furthermore, the system, using the same backend financial institution server may be able to identify an account, merchant code, wallet, or the like associated with the digital resource exchange.

In some embodiments, funding the entity controlled presence on the digital resource exchange further comprises funding the presence with resources from an account associated with the entity, wherein the funding occurs for each payment channel. In some embodiments, reversing the funding from the entity controlled presence on the digital resource exchange further comprises reversing the funding to the account associated with the entity for each payment channel.

As illustrated in block 110, the system may identify the information associated with the transaction across the digital resource exchange. In this way, in order to complete a transaction, the digital resource exchange may provide information associated with the digital resource exchange to the financial institution to process the transaction. As such, the system may be able to identify information about the digital resource exchange and if the digital resource exchange is an exchange.

Next, as illustrated in block 112, the process 100 continues by storing the information for regulatory or policy implementation. In this way, the system may store the information and upon processing of any transaction using that identifier, the financial institution may deny that transaction due to the fact that the merchant is associated with the digital resource exchange that may be non-compliant for policies or regulations.

In some embodiments, the system may identify, based on back end tracking, account information for the account supporting the exchange. In this way, once the transaction occurs across the exchange, the system may be able to identify the account that the digital resource account transmitted funds to. In this way, the system may be able to identify one or more portions of an account number, account owner, or other account information about the account associated with the other side of the transaction across the digital resource exchange. The account may be flagged for policy implementation and regulatory compliance in order to flag accounts to prevent other accounts within the financial institution from transacting with known accounts associated with digital resource exchanges as those may be associated with non-compliant transactions.

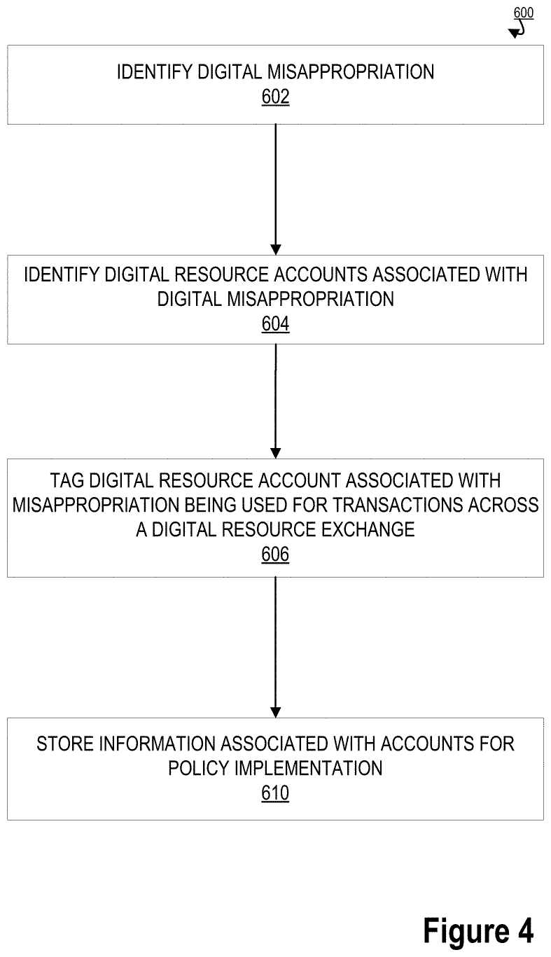

FIG. 4 provides a high level process flow illustrating an identification and tagging of digital wallets associated with a digital resource exchange 600, in accordance with one embodiment of the present invention. As illustrated in block 602, the process 600 is initiated by identifying a digital misappropriation. The digital misappropriation may be some sort of digital non-conforming or non-compliant action, such as a transaction on a digital exchange. In this way, the system may be know of a misappropriation and that a misappropriation associated with a digital resource exchange or the like. The system may know of this historic misappropriation based on processing of the payments associated with the transaction.

Next, as illustrated in block 604, the process 600 continues by identifying the digital resource accounts associated with illicit activity. The accounts are identified based on an indication that the digital resource accounts have been involved in cyber-attacks, prior misappropriation events, involved in law enforcement investigations, and the like. In this way, the system may identify the account associated with the misappropriation, based on processing the transaction and back end processing of the transaction after identification of the transaction being an occurrence of misappropriation occurring in the transaction.

Next, as illustrated in block 606, the process 600 continues by tagging the digital resource accounts that have been identified as being associated with digital misappropriation and identifying those accounts being used on possible digital resource exchanges. In this way, the system may tag the digital resource accounts associated with historic misappropriation and identify them being used in subsequent transactions on a digital resource exchange. As such, the system identifies the digital wallet that is sending or receiving payment across the exchange and track the various transactions on one or more different digital resource exchanges. The system may be able to identify the exchanges and accounts as potentially being involved in misappropriation. As such, the system tracks where the digital resource account is being utilized and identifies the potential digital resource exchange networks that the digital resource account or wallet utilizes based on the tagging.

Finally, as illustrated in block 610, the process 600 is completed by storing the information associated with the digital resource accounts for subsequent policy implementation. In this way, the system may deny all transactions associated with the exchange, accounts, or the like. In other embodiments, the system may track the various accounts or wallets and allow the financial institution to determine, in real-time decisions to accept, deny, or allow for processing for any transactions associated with the accounts.

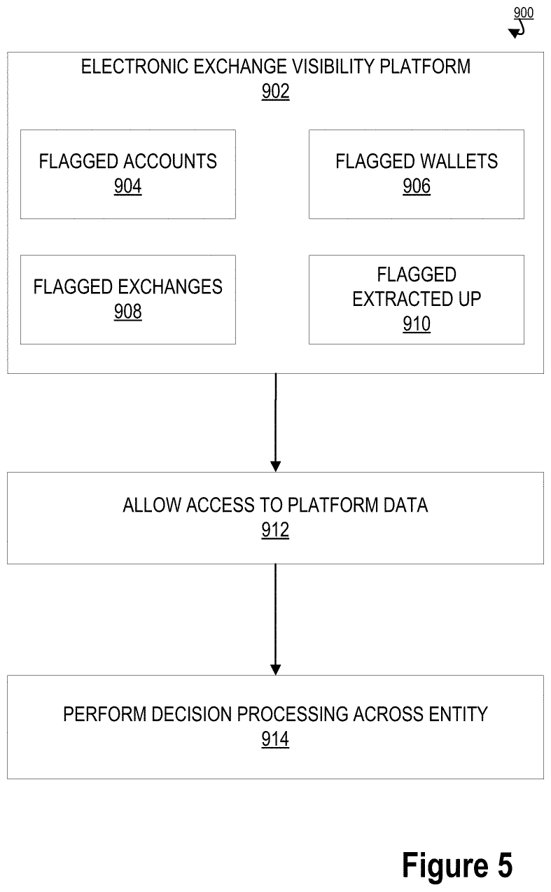

FIG. 5 provides a high level process flow illustrating identifying and tagging using electronic exchange visibility system 900, in accordance with one embodiment of the present invention. As illustrated, the electronic exchange visibility platform 902 provides visualization into flagged accounts 904, flagged exchanges 908, flagged wallets 906, and flagged extracted up data 910.

In some embodiments, flagged accounts 904 may include any accounts identified by the system that may be involved in transactions associated with digital resource exchanges. As such, these transaction and accounts may be non-compliant. In some embodiments flagged exchanges 908 may include any exchanges that may be associated with non-compliant transactions. In some embodiments, flagged wallets 906 may include any wallets associated with non-compliant transactions. In some embodiments, flagged extracted up data 910 may provide the system with data associated with users performing non-compliant transactions.

Next, as illustrated in block 912, the process 900 continues by allowing access to the platform data for the financial institution in order to allow for any financial institution system to deny and/or accept transactions based on the flagging. Finally, as illustrated in block 914, the process 900 is finalized by preforming a decision processing across the entity for each account, wallet, exchange, or the like. As such the decision provides for the financial institution system to determine the approval or denial of transactions being performed by the account, exchange, wallet, or the like.

The system is utilized to identify and tag accounts and exchanges associated with potential digital misappropriation. As such, identifying the accounts supporting digital resource exchanges. The system sets up an account, such as a digital resource account or wallet on that exchange. The system funds and reverses the funding of the digital resource account with entity or financial institution funds. Once a transaction occurs via the exchange, the system may be able to perform back end searching to look up the resource distribution. Doing so, the system identifies the resource account associated with the digital resource exchange. The system tags the account and the exchange and store the tagged information to maintain an inventory of digital resource exchanges and the account used to support the exchanges. The system is utilized as intelligence to flag accounts transacting with the most risky exchanges for regulatory compliance and misappropriation actions.

Embodiments of the invention are directed to a system, method, or computer program product for digital resource exchange visibility. The system identifies information associated with activities on potential digital resource exchanges. The system identifies potential digital resource exchanges and introduces an entity controlled account for funding and reversing funding on a digital resource exchange. The account may be translated to the exchange as a realistic account utilizing the various payment channels for interaction with the digital resource exchange. Once an interaction occurs via the exchange, the system may be able to perform back end searching for data extraction about the interaction. The system is utilized as intelligence to flag interactions.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function. As such, once the software and/or hardware of the claimed invention is implemented the computer device and application-specific circuits associated therewith are deemed specialized computer devices capable of improving technology associated with the in authorization and instant integration of a new credit card to digital wallets.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a special purpose computer for the authorization and instant integration of credit cards to a digital wallet, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for electronic exchange visibility, the system comprising:
a memory device with computer-readable program code stored thereon;
a communication device;
a processing device operatively coupled to the memory device and the communication device, wherein the processing device is configured to execute the computer-readable program code to:
identify a digital resource exchange;
set up an entity controlled presence on the digital resource exchange, wherein the entity controlled presence includes a digital resource account;
fund the entity controlled presence on the digital resource exchange with resources from an account associated with the entity, wherein the funding occurs for each payment channel;
reverse the funding from the entity controlled presence on the digital resource exchange to the account associated with the entity for each payment channel;
extract, via entity based backend processor, information about the digital resource exchange based on the funding and reversing performed, wherein the information about the digital resource exchange further comprises an identification of an appearance of the funding and the reversing on the digital resource exchange for each transaction via each of the payment channels;
tag the extracted information as being associated with the digital resource exchange; and
allow for entity based decisioning for entity user processing on the digital resource exchange.

2. The system of claim 1, wherein decisioning for entity user processing on the digital resource exchange further comprises declining, holding, or accepting entity user transactions across the digital resource exchange.

3. The system of claim 1, wherein the digital resource account comprise one or more payment channels such that upon performing processing on the digital resource exchange via the entity controlled presence using the digital resource account identifies a processing procedure for each of the digital resource accounts on the digital resource exchange.

4. The system of claim 1, wherein the digital resource exchange is a cryptocurrency exchange.

5. The system of claim 1, wherein setting up the entity controlled presence on the digital resource exchange further comprises enrolling the digital resource account on the digital resource exchange for performing transactions across the digital resource exchange via digital resource accounts.

6. The system of claim 1, wherein performing processing on the digital resource exchange via the entity controlled presence, further comprises conducting one or more transactions across the exchange.

7. The system of claim 1, wherein reversing the funding from the entity controlled presence on the digital resource exchange comprises confirming the digital resource exchange uses a matching payment mechanism to extract funds and to fund the digital resource exchange or confirming that there is no match between the payment mechanism used to extract funds and to fund the digital resource entity.

8. A computer program product for electronic exchange visibility, the computer program product comprising at least one non-transitory computer-readable medium having computer-readable program code portions embodied therein, the computer-readable program code portions comprising:
an executable portion configured for identifying a digital resource exchange;
an executable portion configured for setting up an entity controlled presence on the digital resource exchange, wherein the entity controlled presence includes a digital resource account;
an executable portion configured for funding the entity controlled presence on the digital resource exchange with resources from an account associated with the entity, wherein the funding occurs for each payment channel;
an executable portion configured for reversing the funding from the entity controlled presence on the digital resource exchange to the account associated with the entity for each payment channel;
an executable portion configured for extracting, via entity based backend processor, information about the digital resource exchange based on the funding and reversing performed, wherein the information about the digital resource exchange further comprises an identification of an appearance of the funding and the reversing on the digital resource exchange for each transaction via each of the payment channels;
an executable portion configured for tagging the extracted information as being associated with the digital resource exchange; and
an executable portion configured for allowing for entity based decisioning for entity user processing on the digital resource exchange.

9. The computer program product of claim 8, wherein decisioning for entity user processing on the digital resource exchange further comprises declining, holding, or accepting entity user transactions across the digital resource exchange.

10. The computer program product of claim 8, wherein the digital resource account comprise one or more payment channels such that upon performing processing on the digital resource exchange via the entity controlled presence using the digital resource account identifies a processing procedure for each of the digital resource accounts on the digital resource exchange.

11. The computer program product of claim 8, wherein the digital resource exchange is a cryptocurrency exchange.

12. The computer program product of claim 8, wherein setting up the entity controlled presence on the digital resource exchange further comprises enrolling the digital resource account on the digital resource exchange for performing transactions across the digital resource exchange via digital resource accounts.

13. The computer program product of claim 8, wherein performing processing on the digital resource exchange via the entity controlled presence, further comprises conducting one or more transactions across the exchange.

14. The computer program product of claim 8, wherein reversing the funding from the entity controlled presence on the digital resource exchange comprises confirming the digital resource exchange uses a matching payment mechanism to extract funds and to fund the digital resource exchange or confirming that there is no match between the payment mechanism used to extract funds and to fund the digital resource entity.

15. A computer-implemented method for electronic exchange visibility, the method comprising:
providing a computing system comprising a computer processing device and a non-transitory computer readable medium, where the computer readable medium comprises configured computer program instruction code, such that when said instruction code is operated by said computer processing device, said computer processing device performs the following operations:
identifying a digital resource exchange;
setting up an entity controlled presence on the digital resource exchange, wherein the entity controlled presence includes a digital resource account;
funding the entity controlled presence on the digital resource exchange with resources from an account associated with the entity, wherein the funding occurs for each payment channel;
reversing the funding from the entity controlled presence on the digital resource exchange to the account associated with the entity for each payment channel;
extracting, via entity based backend processor, information about the digital resource exchange based on the funding and reversing performed, wherein the information about the digital resource exchange further comprises an identification of an appearance of the funding and the reversing on the digital resource exchange for each transaction via each of the payment channels;
tagging the extracted information as being associated with the digital resource exchange; and
allowing for entity based decisioning for entity user processing on the digital resource exchange.

16. The computer-implemented method of claim 15, wherein decisioning for entity user processing on the digital resource exchange further comprises declining, holding, or accepting entity user transactions across the digital resource exchange.

17. The computer-implemented method of claim 15, wherein the digital resource account comprise one or more payment channels such that upon performing processing on the digital resource exchange via the entity controlled presence using the digital resource account identifies a processing procedure for each of the digital resource accounts on the digital resource exchange.

18. The computer-implemented method of claim 15, wherein setting up the entity controlled presence on the digital resource exchange further comprises enrolling the digital resource account on the digital resource exchange for performing transactions across the digital resource exchange via digital resource accounts.

19. The computer-implemented method of claim 15, wherein performing processing on the digital resource exchange via the entity controlled presence, further comprises conducting one or more transactions across the exchange.

20. The computer-implemented method of claim 15, wherein reversing the funding from the entity controlled presence on the digital resource exchange comprises confirming the digital resource exchange uses a matching payment mechanism to extract funds and to fund the digital resource exchange or confirming that there is no match between the payment mechanism used to extract funds and to fund the digital resource entity.
